(19) United States
(12) Patent Application Publication
(10) Pub. No.: US 2004/0015779 A1
(43) Pub. Date: Jan. 22, 2004

(54) System and method for document search, retrieval, and delivery

(76) Inventor: Gary T. Shorter, Oak Brook, IL (US)

Correspondence Address: John W. Hayes, Rooks Pitts, Suite 2300, 10 South Wacker Drive, Chicago, IL, 60606, US

(21) Appl. No.: 10/619,346

(22) Filed: Jul. 14, 2003

Related U.S. Application Data
(60) Provisional application No. 60/395,886, filed on Jul. 15, 2002.

(51) Int. Cl. G06F 17/00; G06F 17/30; G06F 7/00

(52) U.S. Cl. 715/500; 707/104.1; 707/3; 707/10

(57) ABSTRACT

A system utilizing a remote terminal that enables a user to select and print a document, and then retrieve the document at a remote location. The terminal device may be a web-browser capable wireless device, such as a cellular telephone or PDA (personal digital assistant). The invention may utilize the Internet and a web site with a subscriber-only Extranet for secure logon, to access a document search and retrieval application. In a discount certificate embodiment, a consumer can select a default location or alternate, elect a merchant-based search by entering a merchant name, search through one or more discount coupons being offered by the merchant, and make his selection of one or more coupons. The consumer may select the FAX (facsimile) function with a facsimile telephone number, and the m-Coupon application will automatically FAX the selected coupon to be printed at the merchant's premises FAX machine. In the alternative, the user may direct coupon printing to a printing device, such as a printer directly attached to his cellular phone or PDA. A method for document search, retrieval, and delivery is also disclosed.

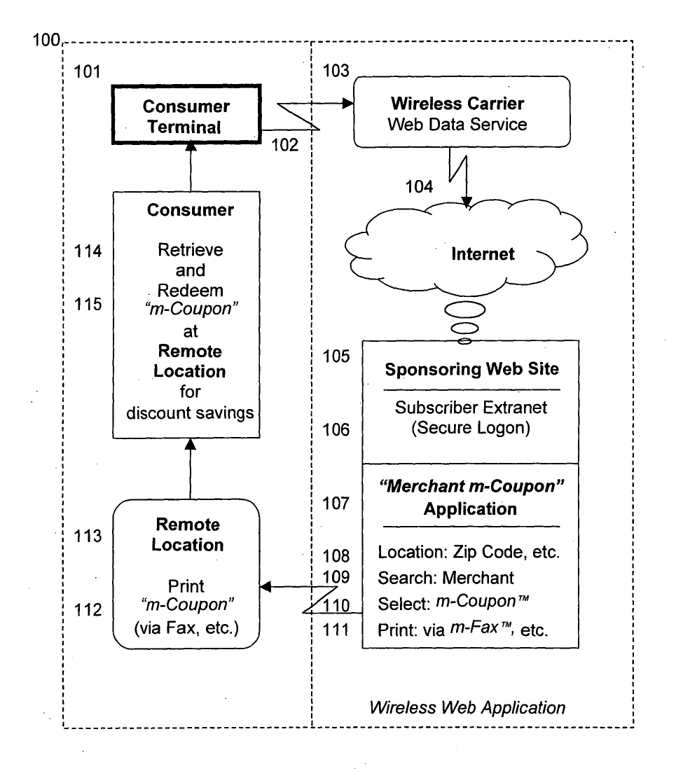

The applicant claims priority based upon U.S. Provisional Application Serial No. 60/395,886 filed Jul. 15, 2002.

### FIELD OF THE INVENTION

This invention relates generally to search and retrieval of documents and in particular to search, retrieval, and delivery of documents utilizing a highly portable terminal device, and is more particularly directed toward searching a data base for document availability, selecting a desired document, and forwarding a hard copy of the document to a remote location.

### BACKGROUND OF THE INVENTION

The distribution of discount certificates and coupons serves the purpose of encouraging consumers to use the goods and services offered by the coupon sponsor. However, since a large number of retail businesses, restaurants, and service providers favor the use of coupons and discount certificates, it can be difficult for the consumer to determine exactly which coupons or certificates he has received. Furthermore, if required to carry along all of his certificates at all times against the eventuality that one might be needed, the consumer would be unreasonably burdened, and may elect to abandon coupon use altogether in frustration.

The development of a database for coupons that indicates where the coupons may be redeemed would provide some relief for the consumer, since, after consulting the database, the consumer would at least know whether a particular coupon or discount certificate is in his possession. But the existence of a reliable database would still not relieve the consumer of the need to carry all of his coupons and discount certificates with him at all times.

Accordingly, a need arises for a system and method that is more than a mere coupon organizer. There is a need for a system that can rapidly apprise a user of the coupons and discount certificates that are in his possession, then enable delivery of the coupon to the location where it can be used without requiring that the user carry all of his coupons and discount certificates along with him.

### SUMMARY OF THE INVENTION

These needs and others are satisfied by the search, retrieval, and delivery system of the present invention. The present invention comprises a remote terminal that enables a user to select and print a document, and then retrieve the document at a remote location. In the preferred form of the invention, the document is a discount certificate which can be printed at a remote location corresponding to a merchant place of business, at which point the discount certificate can be redeemed by the user. These discount certificate documents are sometimes termed “merchant coupons.” The terminal device may be a web-browser capable wireless device, such as a cellular telephone or PDA (personal digital assistant).

The present invention recognizes the need to enable consumers to gain easier access to discount coupons for products and services as a wireless application, that may be termed m-Coupon™. The invention may utilize the Internet and a web site with a subscriber-only Extranet for secure logon, to access the m-Coupon application.

Within the m-Coupon application, the consumer is presented with a choice to select his home location or enter a zip code, city or address to make the search criteria more relevant to his location. Next, the consumer can search by merchant name or by category, such as retail store, service provider, or restaurant, for example. This category search feature can reduce connect time and associated wireless carrier charges.

Once the merchant has been selected, the consumer can scan through one or more discount coupons being offered by the merchant and make his selection of one or more coupons. The consumer may select the FAX (facsimile) function with a facsimile telephone number, and the m-Coupon application will automatically FAX the selected coupon to be printed at the merchant's premises FAX machine.

At the merchant's premises, the consumer would advise a manager or associate to retrieve the printed m-Coupon from the FAX machine (or the consumer may retrieve it himself, depending upon merchant policy). Upon checkout, the consumer receives the discount afforded by the m-Coupon. In an alternative embodiment, the user may direct coupon printing to a printing device directly attached to his cellular phone or PDA.

Not only does this system provide a direct benefit to the consumer, but also businesses that sponsor electronically accessible coupons and discount certificates also benefit from increased patronage. However, the embodiments described above should not be interpreted as limiting the invention only to consumers or merchants. In other implementations of the m-Coupon application, businesses could utilize the invention for location-based retrieval of information that could then be printed at any remote location with a FAX or other printing device. Of course, the system and method described herein are equally applicable to other forms of documents as well, and need not be restricted to merchant coupon applications.

In accordance with one aspect of the present invention, a document delivery system comprises a hand-held terminal device including data input means and display means, a searchable document data base hosted by a computer remote from the terminal device, a communication channel coupling the terminal device to the remote computer, means, responsive to search criteria supplied by a user as data input through the terminal device, for searching the document data base and retrieving one or more documents satisfying the search criteria, means for selecting one or more documents to be delivered from among the documents satisfying the search criteria, means for specifying a delivery destination for the one or more documents selected, and means for providing a physical copy of the document at the delivery destination.

In one form of the invention, the hand-held terminal device comprises a hand-held wireless data terminal, which may be implemented as, for example, a web browser enabled cellular telephone handset or a personal digital assistant. At least a portion of the documents in the searchable document data base may comprise merchant coupons or discount certificates.

In another form of the present invention, the searchable document data base further comprises searchable document records, each document record including searchable information fields containing document attributes. The searchable document data base may further include an image of each document, associated with the corresponding document record, wherein each such image is suitable for document delivery. The communication channel may be a wireless communication channel, which may be implemented using radio frequencies.

In still another form of the invention, the means for searching the document data base comprises a data base application computer program that responds to user-supplied search criteria and provides result indicia for each document that satisfies the criteria. The result indicia may include at least an identifying characteristic for each document retrieved, such as a document name or a portion of the document contents. The result indicia may comprise at least a partial image of each document retrieved.

In yet another form of the invention, the means for selecting one or more documents comprises highlighting one or more of the result indicia to select one or more documents represented by the result indicia using the data input means of the terminal device. The means for specifying a delivery destination may comprise selecting a delivery destination option using the data input means of the terminal device after selecting among the result indicia. An editable default delivery destination may be associated with each document. The means for providing a physical copy of the document at the delivery destination may be a printing device at a location remote from the hand-held terminal device, such as a facsimile machine coupled to the public switched telephone network. In the alternative, the means for providing a physical copy of the document at the delivery destination may be a printing device associated with the hand-held terminal device, such as a thermal printer coupled to the hand-held terminal device itself.

In accordance with another aspect of the present invention, a document delivery system comprises a hand-held wireless data terminal having data input and information display capability, a searchable document data base hosted by a computer remote from the data terminal, the searchable document data base including searchable document records, each document record including searchable information fields containing document attributes, and the document data base further including an image of each document, associated with the corresponding document record, wherein each such image is suitable for document delivery, a radio frequency communication channel coupling the data terminal to the remote computer, wherein the remote computer is accessible through an extranet protocol requiring secure login, a data base application computer program that searches the document data base in response to user-supplied search criteria entered through the data terminal, retrieves all documents satisfying the search criteria, and provides result indicia for each retrieved document utilizing the information display capability of the data terminal, an application computer program resident on the data terminal that interacts with the data base application computer program and provides the user with the capability of highlighting one or more of the result indicia to select one or more documents represented by the result indicia using the data input capability of the data terminal, a data input application computer program resident on the data terminal that allows the user to select a delivery destination option for a selected document using the data input capability of the data terminal by editing, if desired, a default delivery destination associated with the selected document, and a printing device that provides a physical copy of the document at the selected delivery destination.

In accordance with yet another aspect of the present invention, a method for document search, retrieval, and delivery comprises the steps of providing a hand-held terminal device including data input means and display means, providing a searchable document data base hosted by a computer remote from the terminal device, and providing a communication channel coupling the terminal device to the remote computer. The method further comprises the steps of searching the document data base in response to search criteria supplied by a user as data input through the terminal device, retrieving one or more documents satisfying the search criteria, selecting one or more documents to be delivered from among the documents satisfying the search criteria, specifying a delivery destination for the one or more documents selected, and providing a physical copy of the one or more documents selected at the delivery destination.

In accordance with yet a further aspect of the present invention, a method for document search, retrieval, and delivery comprises the steps of providing a hand-held wireless data terminal having data input and information display capability, providing a searchable document data base hosted by a computer remote from the data terminal, the searchable document data base including searchable document records, each document record including searchable information fields containing document attributes, and the document data base further including an image of each document, associated with the corresponding document record, wherein each such image is suitable for document delivery, and providing a radio frequency communication channel coupling the data terminal to the remote computer, wherein the remote computer is accessible through an extranet protocol requiring secure login. The method further comprises the steps of searching the document data base via a data base application computer program that searches the document data base in response to user-supplied search criteria entered through the data terminal, retrieving at least a portion of the documents satisfying the search criteria, providing result indicia for each retrieved document utilizing the information display capability of the data terminal, selecting one or more documents represented by the result indicia by highlighting one or more of the result indicia using the data input capability of the data terminal via an application computer program resident on the data terminal that interacts with the data base application computer program, selecting a delivery destination option for a selected document using the data input capability of the data terminal by editing, if desired, a default delivery destination associated with the selected document via a data input application computer program resident on the data terminal, and providing a physical copy of the document to a printing device at the selected delivery destination.

Further objects, features, and advantages of the present invention will become apparent from the following description and drawing.

### BRIEF DESCRIPTION OF THE DRAWING

The single drawing depicts the general process flow of how a consumer uses a portable terminal to access the sponsoring web site over the Internet and logon to the m-Coupon application, then proceed through various selection steps and print the m-Coupon at a remote location.

### DETAILED DESCRIPTION OF THE INVENTION

There is described herein a search, retrieval, and delivery system that offers distinct advantages when compared to the prior art. The system is illustrated in block diagram form in the drawing figure, generally depicted by the numeral 100.

In accessing the system 100 in accordance with the present invention, a consumer 101 uses a terminal) device 102 to access his wireless carrier's service 103 for access to the Internet 104. The terminal device may be any device suitable for use as a portable terminal, such as a web-enabled cellular telephone handset, or a PDA, for example. Upon accessing the Internet, the consumer 101 enters the URL for the subscription service web site 105 and proceeds to logon to a secure Extranet 106 where the consumer is given access to the m-Coupon application 107.

Upon access to the application, the consumer 101 may use his default location information, or enter a change of location with city, state, and/or zip code 108. The consumer 101 then searches the database 109. One possible search method begins by entering the name of a merchant and then choosing an m-Coupon 110 when presented with coupon options for that merchant.

The consumer 101 selects the m-Fax function 111 to direct printing of the m-Coupon to the facsimile machine 112 at the merchant's premises 113. At the merchant's premises 113, the consumer 101 retrieves 114 the m-Coupon from the merchant manager or assistant (or the consumer may retrieve it himself, as noted above), and proceeds to redeem 115 the m-Coupon to realize a saving or discount on products and/or services.

One of the benefits of the present invention is that it enables consumers to have access anywhere and at any time, via a remote terminal such as a wireless device, to access, select and print discount m-Coupons and retrieve them at a remote location. This remote location can be a merchant's premises, using well-established facsimile machines to produce a hard copy. In the alternative, as explained previously, the printing device may be a printer or FAX that is physically connected to the remote terminal device the customer is using.

An additional benefit of the present invention is the immediate return on investment the consumer can realize with the amount of money saved via the m-Coupon, when viewed with respect to the cost of the wireless device, access to the Internet, and connection charges imposed by the consumer's wireless carrier.

In addition, merchants who participate in the service described will realize a competitive advantage in their market by giving the consumer easier access to the merchant's discount coupons, which enables greater business volume and sales for the merchant. Also, this m-Coupon wireless application generates demand for web browser capable wireless devices and cell phones, and Internet data services provided by the wireless carriers.

Consumer use of the present invention as described herein should not be interpreted as limiting the invention's application to other areas, such as business-to-business, where sales personnel may utilize the invention when traveling, or at remote customer locations, even while entertaining at a restaurant, for example. Business people may find other applications for this invention while traveling or attending trade shows, to access documents via a wireless device and select fax printing remotely. By using the well-established fax machine as the enabling printing device, the invention eliminates the need for complex network connections to traditional printers, while a fax phone number is readily available (often published), and the inexpensive fax machine is easily accessible. Of course, a stand-alone printing device attached to the user's remote terminal, or otherwise interconnected with a wireless network, is also a convenient printing medium.

The present invention further includes the capability to remotely access a portable database, searchable by location and/or specific merchant name, with associated discount coupons that can be accessed via a wireless device using the Internet. This invention includes a direct link from the searchable database to merchant information for FAX- or print-enabled communications using wireless devices. Additionally, the invention is not limited to remote printing at only a merchant's premises, but is usable at any remote location, using not only facsimile, but potentially other print-enabling technologies, such as wireless printers, non-attached printers, infrared, wireless LANs, or any other print-enabling technology or hard copy communication capability.

There has been described herein a search, retrieval, and delivery system for discount certificates that offers distinct advantages when compared with the prior art. It will be apparent to those skilled in the art that modifications may be made without departing from the spirit and scope of the invention. Accordingly, it is not intended that the invention be limited except as may be necessary in view of the appended claims.

What is claimed is:

1. A document delivery system comprising:
a hand-held terminal device including data input means and display means;
a searchable document data base hosted by a computer remote from the terminal device;
a communication channel coupling the terminal device to the remote computer;
means, responsive to search criteria supplied by a user as data input through the terminal device, for searching the document data base and retrieving one or more documents satisfying the search criteria;
means for selecting one or more documents to be delivered from among the documents satisfying the search criteria;
means for specifying a delivery destination for the one or more documents selected; and
means for providing a physical copy of the document at the delivery destination.

2. The document delivery system of claim 1, wherein the hand-held terminal device comprises a hand-held wireless data terminal.

3. The document delivery system of claim 1, wherein at least a portion of the documents in the searchable document data base comprises merchant coupons.

4. The document delivery system of claim 1, wherein the searchable document data base further comprises searchable document records, each document record including searchable information fields containing document attributes.

5. The document delivery system of claim 4, wherein the searchable document data base further includes an image of each document, associated with the corresponding document record, wherein each such image is suitable for document delivery.

6. The document delivery system of claim 1, wherein the means for searching the document data base comprises a data base application computer program that responds to user-supplied search criteria and provides result indicia including at least an identifying characteristic for each document retrieved that satisfies the criteria.

7. The document delivery system of claim 6, wherein the identifying characteristic comprises at least a portion of the document contents.

8. The document delivery system of claim 6, wherein the result indicia comprises at least a partial image of each document retrieved.

9. The document delivery system of claim 6, wherein the means for selecting one or more documents comprises highlighting one or more of the result indicia to select one or more documents represented by the result indicia using the data input means of the terminal device.

10. The document delivery system of claim 6, wherein the means for specifying a delivery destination comprises selecting a delivery destination option using the data input means of the terminal device after selecting among the result indicia.

11. The document delivery system of claim 10, wherein an editable default delivery destination is associated with each document.

12. The document delivery system of claim 1, wherein the means for providing a physical copy of the document at the delivery destination comprises a printing device at a location remote from the hand-held terminal device.

13. The document delivery system of claim 1, wherein the means for providing a physical copy of the document at the delivery destination comprises a printing device associated with the hand-held terminal device.

14. A document delivery system comprising:
a hand-held wireless data terminal having data input and information display capability;
a searchable document data base hosted by a computer remote from the data terminal, the searchable document data base including searchable document records, each document record including searchable information fields containing document attributes, and the document data base further including an image of each document, associated with the corresponding document record, wherein each such image is suitable for document delivery;
a radio frequency communication channel coupling the data terminal to the remote computer, wherein the remote computer is accessible through an extranet protocol requiring secure login;
a data base application computer program that searches the document data base in response to user-supplied search criteria entered through the data terminal, retrieves all documents satisfying the search criteria, and provides result indicia including at least an identifying characteristic for each retrieved document utilizing the information display capability of the data terminal;
an application computer program resident on the data terminal that interacts with the data base application computer program and provides the user with the capability of highlighting one or more of the result indicia to select one or more documents represented by the result indicia using the data input capability of the data terminal;
a data input application computer program resident on the data terminal that allows the user to select a delivery destination option for a selected document using the data input capability of the data terminal by editing, if desired, a default delivery destination associated with the selected document; and
a printing device that provides a physical copy of the document at the selected delivery destination.

15. The document delivery system of claim 14, wherein the hand-held wireless data terminal comprises a web browser enabled cellular telephone handset.

16. The document delivery system of claim 14, wherein at least a portion of the documents in the searchable document data base comprises merchant coupons.

17. The document delivery system of claim 14, wherein the identifying characteristic comprises at least a portion of the document contents.

18. The document delivery system of claim 14, wherein the result indicia comprises at least a partial image of each document retrieved.

19. The document delivery system of claim 14, wherein the printing device is located remotely from the hand-held wireless data terminal.

20. The document delivery system of claim 14, wherein the printing device comprises a printer associated with the hand-held wireless data terminal.

21. A method for document search, retrieval, and delivery, the method comprising the steps of:
(a) providing a hand-held terminal device including data input means and display means;
(b) providing a searchable document data base hosted by a computer remote from the terminal device;
(c) providing a communication channel coupling the terminal device to the remote computer;
(d) searching the document data base in response to search criteria supplied by a user as data input through the terminal device;
(e) retrieving one or more documents satisfying the search criteria;
(f) selecting one or more documents to be delivered from among the documents satisfying the search criteria;
(g) specifying a delivery destination for the one or more documents selected; and
(h) providing a physical copy of the one or more documents selected at the delivery destination.

22. The method in accordance with claim 21, wherein the step (a) of providing a hand-held terminal device further comprises the step of providing a hand-held wireless data terminal.

23. The method in accordance with claim 21, wherein the step (b) of providing a searchable document data base further comprises the step of providing a searchable document data base wherein at least a portion of the documents in the searchable document data base comprises merchant coupons.

24. The method in accordance with claim 21, wherein the step (b) of providing a searchable document data base further comprises the step of providing a searchable document data base including searchable document records, each document record including searchable information fields containing document attributes.

25. The method in accordance with claim 24, wherein the searchable document data base further includes an image of each document, associated with the corresponding document record, wherein each such image is suitable for document delivery.

26. The method in accordance with claim 21, wherein the step (d) of searching the document data base further comprises the step of searching the document data base via a data base application computer program that responds to user-supplied search criteria and provides result indicia including at least an identifying characteristic for each document retrieved that satisfies the criteria.

27. The method in accordance with claim 26, wherein the identifying characteristic comprises at least a portion of the document contents.

28. The method in accordance with claim 26, wherein the result indicia comprises at least a partial image of each document retrieved.

29. The method in accordance with claim 21, wherein the step (f) of selecting one or more documents further comprises the step of selecting one or more document by highlighting one or more of the result indicia to select one or more documents represented by the result indicia using the data input means of the terminal device.

30. The method in accordance with claim 21, wherein the step (g) of specifying a delivery destination further comprises the step of selecting a delivery destination option using the data input means of the terminal device after selecting among the result indicia.

31. The method in accordance with claim 30, wherein an editable default delivery destination is associated with each document.

32. The method in accordance with claim 21, wherein the step (h) of providing a physical copy of the document at the delivery destination further comprises the step of providing a physical copy of the document at a printing device located remotely from the hand-held terminal device.

33. The method in accordance with claim 21, wherein the step (h) of providing a physical copy of the document at the delivery destination further comprises the step of providing a physical copy of the document at a printing device associated with the hand-held terminal device.

34. A method for document search, retrieval, and delivery, the method comprising the steps of:
(a) providing a hand-held wireless data terminal having data input and information display capability;
(b) providing a searchable document data base hosted by a computer remote from the data terminal, the searchable document data base including searchable document records, each document record including searchable information fields containing document attributes, and the document data base further including an image of each document, associated with the corresponding document record, wherein each such image is suitable for document delivery;
(c) providing a radio frequency communication channel coupling the data terminal to the remote computer, wherein the remote computer is accessible through an extranet protocol requiring secure login;
(d) searching the document data base via a data base application computer program that searches the document data base in response to user-supplied search criteria entered through the data terminal;
(e) retrieving at least a portion of the documents satisfying the search criteria;
(f) providing result indicia including at least an identifying characteristic for each retrieved document utilizing the information display capability of the data terminal;
(g) selecting one or more documents represented by the result indicia by highlighting one or more of the result indicia using the data input capability of the data terminal via an application computer program resident on the data terminal that interacts with the data base application computer program;
(h) selecting a delivery destination option for a selected document using the data input capability of the data terminal by editing, if desired, a default delivery destination associated with the selected document via a data input application computer program resident on the data terminal; and
(i) providing a physical copy of the document to a printing device at the selected delivery destination.

35. The method in accordance with claim 34, wherein the step (a) of providing a hand-held wireless data terminal further comprises the step of providing a web browser enabled cellular telephone handset for use as a hand-held wireless data terminal.

36. The method in accordance with claim 34, wherein the step (b) of providing a searchable document data base further comprises the step of providing a searchable document data base wherein at least a portion of the documents in the searchable document data base comprises merchant coupons.

37. The method in accordance with claim 34, wherein the identifying characteristic comprises at least a portion of the document contents.

38. The method in accordance with claim 34, wherein the step (f) of providing result indicia further comprises the step of providing result indicia comprising at least a partial image of each document retrieved.

39. The method in accordance with claim 34, wherein the step (i) of providing a physical copy of the document further comprises the step of providing a physical copy of the document to a printing device located remotely from the handheld wireless data terminal.

40. The method in accordance with claim 34, wherein the step (i) of providing a physical copy of the document further comprises the step of providing a physical copy of the document to a printing device associated with the hand-held wireless data terminal.
